(19) United States
(12) Patent Application Publication
(10) Pub. No.: US 2011/0173885 A1
(43) Pub. Date: Jul. 21, 2011

(54) ATMOSPHERIC PRESSURE GASIFICATION PROCESS AND SYSTEM

(75) Inventors: William Davey, Mississauga (CA); Michael Trovant, Toronto (CA)

(73) Assignee: HATCH LTD., Mississauga (CA)

(21) Appl. No.: 13/009,511

(22) Filed: Jan. 19, 2011

Related U.S. Application Data
(60) Provisional application No. 61/296,151, filed on Jan. 19, 2010.

(51) Int. Cl. B01J 7/00; B65G 33/08

(52) U.S. Cl. 48/61; 198/657; 198/674; 198/617

(57) ABSTRACT

A fuel supply system for supplying pulverized feedstock to a gasifier includes a feedstock storage apparatus for storing pulverized feedstock. The feedstock storage apparatus operates at a first pressure. The fuel supply system also includes a mechanical conveyance apparatus linking the feedstock storage apparatus to a fuel distribution apparatus. The mechanical conveyance apparatus is operable to continuously convey the pulverized feedstock from the feedstock storage apparatus to the fuel distribution apparatus at a first flow rate. The fuel distribution apparatus operates at a second pressure that is greater than the first pressure. The fuel distribution apparatus includes at least one outlet communicably connected to at least one burner on the gasifier for transferring pulverized feedstock from the fuel distribution apparatus to the at least one burner.

### CROSS-REFERENCE TO RELATED APPLICATION

This application claims the benefit of 35 USC 119 based on the priority of co-pending U.S. Provisional Patent Application 61/296,151, filed Jan. 19, 2010, which is incorporated herein in its entirety by reference.

### FIELD

The present invention relates generally to a process for gasifying a solid carbonaceous feedstock such as coal, specifically a process for gasifying the solid carbonaceous feedstock at approximately atmospheric pressure.

### INTRODUCTION

Known commercial scale coal gasification plants operate at elevated pressures, typically between 2 and 4 MPa, and are commonly referred to as pressurized or high pressure coal gasification plants. Gasifiying coal at elevated pressures is conventionally perceived to require less expensive equipment and consume less energy when compared to low or atmospheric pressure gasification processes.

In a low pressure system, the gas synthesis product, or syngas, must be compressed for subsequent downstream applications. In a high pressure coal gasification plant, although the upstream oxygen supply must be compressed, the syngas product requires no further compression.

Typically the energy required to compress the upstream oxygen supply in a high pressure plant is two to three times less than the energy required to compress the syngas product of a low pressure system. Also, the equipment required to gasify large amounts of coal in a high pressure system is smaller, and accordingly is commonly believed to be less expensive, than the equipment required to process a corresponding amounts of coal at low pressure.

Notwithstanding these apparent advantages of a high pressure plant, it should also be recognized that transporting solid fuels (in the form of coal or pulverized coal) across a pressure boundary is a complicated process requiring specialized, custom fabricated equipment that is both expensive and difficult to maintain. High equipment cost and poor reliability reduce the overall economics of high pressure coal gasification plants, and the commercialization of such plants has been very limited as a result.

### SUMMARY

In accordance with a first aspect there is provided a process for gasifying a solid carbonaceous feedstock, comprising the steps of: i) providing a supply of pulverized feedstock, ii) drying the pulverized feedstock in a dryer using a dryer stream, iii) pneumatically conveying an input stream into a gasifier, the input stream comprising the dried pulverized feedstock entrained within a conveying gas, iv) simultaneously introducing an oxidizing stream into the gasifier to react with the input stream, v) gasifying the pulverized feedstock by combusting the input stream in the presence of the oxidizing stream to produce an exhaust stream, the exhaust stream comprising syngas and entrained flyash, vi) providing a heat exchanger in communication with the exhaust stream downstream of the gasifier and with the dryer stream upstream from the dryer, and vii) passing the exhaust stream and the dryer stream through the heat exchanger to transfer heat from the exhaust stream to the dryer stream before the dryer stream enters the dryer.

In some embodiments the process further comprises the step of passing the exhaust stream through a filter upstream of the heat exchanger to separate at least a portion of the flyash from the exhaust stream before the exhaust stream is passed through the heat exchanger.

In some embodiments the process further comprises the step of providing a flyash stream and combining the flyash stream with the input stream upstream of the gasifier, the flyash stream comprising at least a portion of the flyash separated from the exhaust stream by the filter entrained in a filter cleaning gas.

In some embodiments the process further comprises the step of passing the exhaust stream through an injection cooler provided downstream of the heat exchanger, the injection cooler having a water supply stream and a water removal stream.

In some embodiments, the process further comprises the step of recirculating at least a portion of the water removal stream into the water supply stream upstream of the injection cooler.

In some embodiments at least one of the input stream, exhaust stream, dryer stream and the flyash stream is operated at a pressure between 0.7 and 2.0 atmospheres.

In accordance with a related aspect there is provided a system for use in a gasification plant, the system comprising a dryer for drying pulverized feedstock prior to gasification using a dryer stream and a gasifier downstream of the dryer. The gasifier is configured to receive an input stream and an oxidizing stream and to expel at least an exhaust stream. The input stream comprises pulverized feedstock from the dryer entrained within a conveying fluid, and the exhaust stream comprises flyash entrained within syngas. The system also comprises a heat exchanger in communication with the exhaust stream downstream of the gasifier and with the dryer stream upstream of the dryer. The heat exchanger is operable to transfer heat from the exhaust stream to the dryer stream when in use.

In some embodiments the system further comprises a filter in communication with the exhaust stream downstream of the gasifier for removing at least a portion of the flyash from the exhaust stream.

In some embodiments the heat exchanger may be downstream of the filter.

In some embodiments the filter is a bag filter and the bag filter is sealed to inhibit the escape of the exhaust stream from the system.

In some embodiments the system comprises a flyash stream communicably linking the filter and the input stream for introducing at least a portion of the flyash removed from the exhaust stream by the filter into the input stream.

In some embodiments, the system also comprises an injection cooler in communication with the exhaust stream downstream of the heat exchanger. The injection cooler comprises a water supply stream and a water removal stream and the water removal stream is connected to the water supply stream for recirculating at least a portion of the water removal stream into the water supply stream.

In some embodiments at least one of the input stream, exhaust stream, dryer stream and the flyash stream are at a pressure between 0.7 and 2.0 atmospheres.

Thus, as contemplated, a process and system for gasifying a feedstock may comprise a gasifier that is operable to receive and react an input stream, comprising pulverized feedstock and an oxidizing stream, comprising an oxidizing agent. The products of the gasification reaction may form an exhaust stream that is extracted from the gasifier. The exhaust stream may exit the gasifier at high temperatures and may have to be cooled before undergoing subsequent treatment. The process may also include the step of drying the pulverized feedstock prior to gasification using a dryer stream within a dryer. The feedstock drying process may be improved (i.e. may have higher efficiency or shorter drying times) if the dryer stream is heated prior to entering the dryer. A heat exchanger may be introduced to the gasification process to transfer heat from the exhaust stream to the dryer stream. The heat exchanger may be positioned to receive the exhaust stream downstream from the gasifier and to receive the dryer stream upstream of the dryer. Such a process, and the system configured to enable such a process, may increase the efficiency of the gasification process.

In accordance with a further aspect there is provided a process for gasifying a feedstock, comprising the steps of: i) pneumatically conveying an input stream into a gasifier, the input stream comprising pulverized feedstock entrained with a conveying gas, ii) simultaneously introducing an oxidizing stream into the gasifier to react with the input stream, iii) gasifying the pulverized coal by burning the input stream in the presence of the oxidizing stream and in the absence of added water and at a pressure between 0.7 and 2.0 atmospheres, iv) withdrawing at least an exhaust stream from the gasifier, the exhaust stream comprising flyash entrained with syngas and v) sending the exhaust stream for further processing.

In some embodiments the step of sending the exhaust stream for further processing comprises providing a filter downstream of the gasifier and passing the exhaust stream through the filter to separate at least a portion of the flyash from the exhaust stream.

In some embodiments the filter is selected from the group consisting of cyclone filter, a bag filter and combination cyclone and bag filter.

In some embodiments the process comprises the step of withdrawing at least a portion of the separated flyash from the filter as a flyash stream and combining the flyash stream with the input stream before the input stream is conveyed into the gasifier.

In some embodiments the step of sending the exhaust stream for further processing comprises providing a coal dryer stream and a heat exchanger in communication with the exhaust stream downstream of the gasifier and passing the exhaust stream and the dryer stream through the heat exchanger to transfer heat from the exhaust stream to the dryer stream.

In accordance with a related aspect there is provided a system for use in a gasification plant, the system comprising a gasifier for receiving an input and an oxidizing stream and for expelling an exhaust stream. The input stream comprises pulverized feedstock within a conveying fluid and the exhaust stream comprises flyash entrained within syngas. The input and oxidizing streams are free from added water so that any water received in the gasifier is substantially limited to moisture contained in the pulverized feedstock.

In some embodiments the gasifier is operated at a pressure between 0.7 and 2.0 atmospheres.

In some embodiments, the system comprises a dryer upstream of the gasifier for drying the pulverized coal using a dryer stream.

In some embodiments, the system comprises a heat exchanger for transferring heat from the exhaust stream to the dryer stream, the heat exchanger being in communication with the exhaust stream downstream of the gasifier and with the dryer stream upstream of the dryer.

In some embodiments, the system comprises a filter for removing at least a portion of the flyash from the exhaust stream, the filter being in communication with the exhaust stream between the gasifier and the heat exchanger

In some embodiments at least a portion of the flyash removed by the filter is conveyed via a flyash stream, the filter being communicably linked to the input stream so that the flyash stream is introduced to the input stream upstream of the gasifier.

Thus, as contemplated, a gasification process and related gasification system may comprise input and oxidizing streams that are free from added water, in the form of liquid water, ice, steam or water vapour. In the absence of intentionally added water, moisture introduced into the gasifier during the gasification process may be substantially limited to the moisture contained within the pulverized feedstock to be gasified. Although the pulverized feedstock may be dried before entering the gasifier, the feedstock may still retain some moisture. However, while some moisture may still enter the gasifier, operating the gasifier in the absence of intentionally added water may reduce the total volume of the exhaust stream exiting the gasifier and thereby reduce the energy required to compress or otherwise treat the exhaust stream downstream from the gasifier.

In accordance with a further aspect there is provided a process for gasifying a feedstock, comprising the steps of: i) pneumatically conveying an input stream into a gasifier, the input stream comprising pulverized feedstock entrained with a conveying gas, ii) simultaneously introducing an oxidizing stream into the gasifier to react with the input stream, iii) gasifying the pulverized feedstock by burning the input stream in the presence of the oxidizing stream at a pressure that is higher than atmospheric pressure, iv) withdrawing at least an exhaust stream from the gasifier, the exhaust stream comprising flyash entrained with syngas and v) providing a bag filter made of fabric downstream of the gasifier and passing the exhaust stream through the filter to separate at least a portion of the flyash from the exhaust stream.

In some embodiments the pressure is between 0.7 and 2.0 atmospheres.

In some embodiments the process also comprises conveying at least a portion of the flyash separated by the filter in a flyash stream and combining the flyash stream with the input stream upstream of the gasifier.

In some embodiments the process also comprises the step of using a dryer to dry the pulverized feedstock using a dryer stream prior to feeding the pulverized feedstock into the gasifier.

In some embodiments the process also comprises the step of providing a heat exchanger and passing both the exhaust and dryer streams through the heat exchanger to transfer heat from the exhaust stream to the dryer stream.

In accordance with a related aspect there is provided a system for use in a gasification plant, the system comprising a gasifier receiving an input stream and an oxidizing stream and expelling an exhaust stream and a slag stream. The input stream comprises pulverized feedstock entrained within a conveying fluid, and the exhaust stream comprises flyash entrained within syngas. The system also comprises a bag filter made of fabric downstream of the gasifier for receiving the exhaust stream and removing at least a portion of the flyash from the exhaust stream, being operable at a pressure that is higher than atmospheric pressure.

In some embodiments the pressure is between 0.7 and 2.0 atmospheres.

In some embodiments the filter is sealed to inhibit leakage of the exhaust stream.

In some embodiments the system further comprises a dryer upstream of the gasifier, for drying the pulverized feedstock using a dryer stream.

In some embodiments the system further comprises a heat exchanger for transferring heat from the exhaust stream to the dryer stream, the heat exchanger may be in communication with the exhaust stream downstream of the gasifier and with the dryer stream upstream of the dryer.

In some embodiments the filter is positioned between the gasifier and the heat exchanger.

In some embodiments at least a portion of the flyash removed by the filter is conveyed via a flyash stream, the filter being communicably linked to the input stream so that the flyash stream is introduced to the input stream upstream of the gasifier. Thus, as contemplated, a process and system for gasifying a feedstock may be carried out at a positive pressure (generally between 0.7 and 2.0 atmospheres) and may comprise a filter in the exhaust stream that is configured to operate at the positive pressure. The filter may be sealed or otherwise made gas-tight to reduce or prevent leakage of gas from the exhaust stream into the surrounding environment.

In accordance with a further aspect, there is provided a fuel supply system for supplying pulverized feedstock to a gasifier. The fuel supply system can comprise a feedstock storage apparatus for storing at least pulverized feedstock. The feedstock storage apparatus can operate at a first pressure. The fuel supply system can also include a mechanical conveyance apparatus communicably linking the feedstock storage apparatus to a fuel distribution apparatus. The mechanical conveyance apparatus is operable to continuously convey the pulverized feedstock from the feedstock storage apparatus to the fuel distribution apparatus at a first flow rate. The fuel distribution apparatus can operate at a second pressure which is greater than the first pressure. The fuel distribution apparatus can include at least one outlet communicably connected to at least one burner on the gasifier for transferring pulverized feedstock from the fuel distribution apparatus to the at least one burner.

In some examples, the mechanical conveyance apparatus is configured to convey at least pulverized feedstock from the feedstock storage apparatus to the fuel distribution apparatus in the absence of a pneumatic conveying fluid.

In some examples, the second pressure is between 0.25 and 3.0 atmospheres greater than the first pressure.

In some examples, the mechanical conveyance apparatus is configured to provide a sealing member for maintaining the second pressure in the fuel distribution apparatus and inhibiting a back flow of pulverized feedstock from the fuel distribution apparatus to the feed hopper.

In some examples, the mechanical conveyance apparatus is a dust pump comprising a housing having an inlet connected to the feedstock storage apparatus, an outlet connected to the fuel distribution apparatus and a housing extending therebetween. The dust pump can also include an auger rotatably received within the housing for conveying pulverized feedstock from the inlet to the outlet and a motor drivingly connected to the auger for selectably rotating the auger.

In some examples, the auger comprises a central shaft. The central shaft and housing can cooperate to define a compression portion that is operable to compress the pulverized feedstock into a plug which forms the sealing member.

According to a related aspect, there is provided a process of supplying fuel to a gasifier having a plurality of burners, the process comprising the steps of a) providing a supply of fuel contained in a feedstock storage apparatus, the feedstock storage apparatus operating at a first pressure; b) providing a mechanical conveyance apparatus that communicably links the feedstock storage apparatus to a fuel distribution apparatus, the fuel distribution apparatus operating at a second pressure that is higher than the first pressure; c) operating the mechanical conveyance apparatus to continuously convey at least a portion of the fuel from the feedstock storage apparatus to the fuel distribution apparatus at a first flow rate; and d) continuously supplying the fuel at a second flow rate from the fuel distribution apparatus to the plurality of burners.

In some examples, step (c) comprises conveying the fuel from the feedstock storage apparatus to the fuel distribution apparatus in the absence of a conveying fluid.

In some examples, the first flow rate is a constant flow rate.

In some examples, step (c) comprises selecting the first constant flow rate from a plurality of predetermined flow rates.

In some examples, the process further comprises the step of adjusting the first flow rate based on an operating condition of the gasifier.

In some examples, the mechanical conveyance apparatus comprises an inlet in communication with the feedstock storage apparatus and an outlet in communication with the fuel distribution apparatus and a housing extending therebetween and step (c) comprises conveying the fuel within the housing from the inlet to the outlet.

In some examples, wherein the mechanical conveyer comprises a compression portion and step (c) further comprises compressing the fuel in the compression section to create a vapour impermeable plug that forms a sealing member between the coal storage apparatus and the fuel distribution apparatus.

### DRAWINGS

For a better understanding of the atmospheric pressure gasification process of the present invention and to show more clearly how embodiments of the invention may be carried into effect, reference will now be made, by way of example only, to the accompanying drawings, in which:

FIG. 1 is a schematic representation of an atmospheric pressure coal gasification system;

FIG. 2 is a more detailed schematic representation of the coal supply portion of the coal gasification system of FIG. 1;

FIG. 3 is a flow chart illustrating an embodiment of a coal gasification process;

FIG. 4 is a schematic representation of another example of a fuel supply portion of the coal gasification system of FIG. 1; and

FIG. 5 is a partial cross sectional view of an example of a dust pump.

For simplicity and clarity of illustration, elements shown in the figures have not necessarily been drawn to scale. For some embodiments, the dimensions of some of the elements may be exaggerated relative to other elements for clarity. Further, where considered appropriate, reference numerals may be repeated among the figures to indicate corresponding or analogous elements.

### DESCRIPTION OF VARIOUS EMBODIMENTS

An atmospheric gasification system can be used to convert any suitable solid, carbonaceous feedstock into a desired gaseous product while operating at pressures generally between 0.7 and 5 atmospheres. The feedstock that is input into the gasification system can be any solid feed material that can be converted to relatively small particles, for example a powder, that can be combusted in a gasifier. Examples of such feedstock materials can include coal, biomass (including wood products, leaves and agricultural products), petroleum coke and other carbonaceous materials. For clarity, one embodiment of an atmospheric gasification system using coal as a feedstock material is described in detail below. Other embodiments of the atmospheric gasification system can be configured to utilize other feedstock materials.

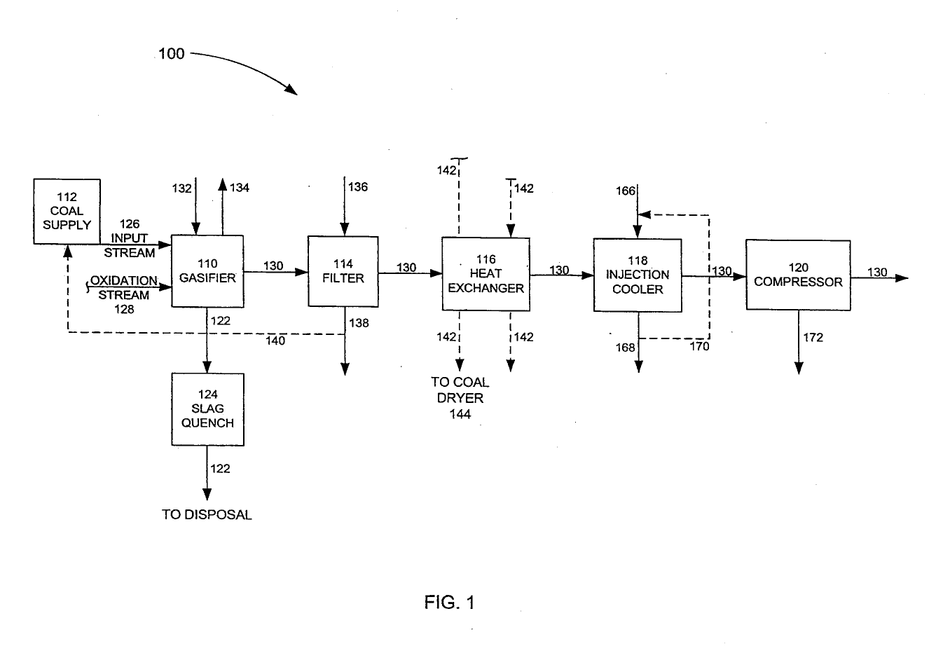

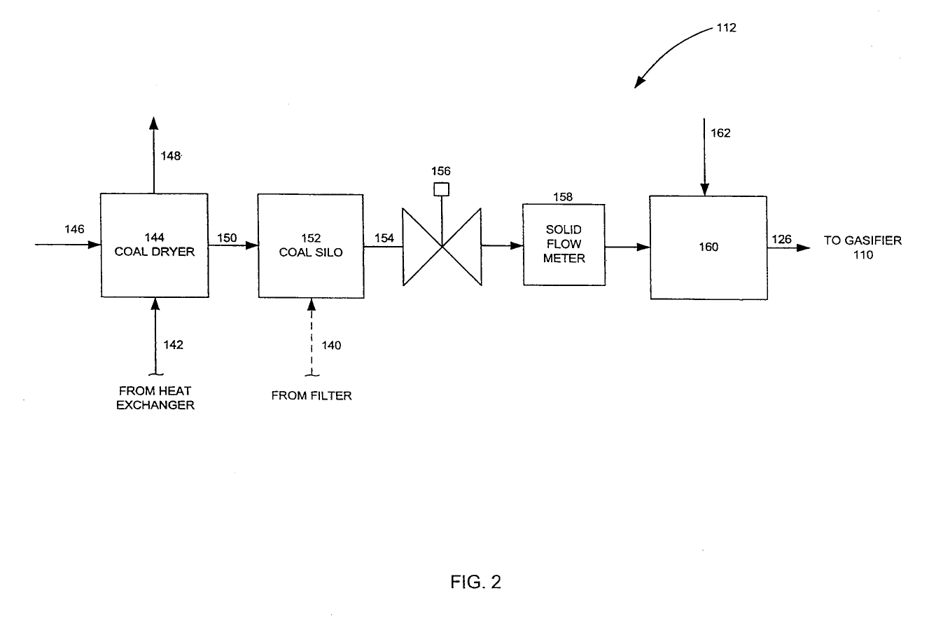

Referring to FIGS. 1 and 2, an embodiment of a coal gasification system is illustrated. The coal gasification system 100 includes a gasifier 110, a coal supply 112, a filter 114, a heat exchanger 116, an injection cooler 118 and a compressor 120. The coal gasification system 100 may be used within, or form a part of, a larger coal gasification plant or production facility.

The gasifier 110 (also referred to as a gasification chamber or reactor) is a vessel in which pulverized coal is reacted with a sub-stoichiometric supply of oxygen to produce a gaseous product commonly referred to as synthesis gas, or syngas. The gasifier 110 may be any suitable gasifier, capable of operating at atmospheric pressure (as described in detail below), such as the gasifier described in U.S. Pat. No. 6,312,482.

The syngas produced by the gasifier 110 is a mixture of gaseous carbon monoxide, hydrogen, water vapour and carbon dioxide, and may also include smaller or trace amounts of other gases including hydrogen sulphide, carbonyl sulphide, hydrogen cyanide, ammonia and methane. In addition to the syngas products, the reaction in the gasifier 110 also produces solid by-products in the form of ash. Some of the ash created during the gasification process forms a slurry of partially melted and partially solid ash material commonly referred to as slag. In the example illustrated, the slag is removed from the gasifier 110 as a slag stream 122. The slag stream 122 is fed into a slag quencher 124, in which the slag is quenched in a liquid water bath, cooled into a solid state and sent for disposal. Other portions, of the ash become entrained with the gaseous reaction products (or process products), for example the syngas, and are carried downstream with the process products. Ash particles entrained in the gaseous process products are commonly referred to as flyash.

In the coal gasification system 100 illustrated, the pulverized coal is fed from the coal supply 112 into the gasifier 110 in the form of an input stream 126. The input stream 126 (also referred to as the coal stream or fuel stream) contains pulverized coal entrained in a conveying fluid or conveying gas. The conveying fluid acts as a carrier for transporting the pulverized coal into the gasifier 110. The conveying fluid can be any suitable fluid, including inert gases such as nitrogen, carbon dioxide or argon, or recycled/recirculated syngas. The oxygen is transported to the gasifier 110 in an oxidizing stream 128 (or oxygen stream). In some examples the oxidizing stream 128 consists of pure, gaseous oxygen, and in other examples the oxidizing stream 128 includes a mixture of oxygen and other gases. The incoming flow rates of both the input stream 126 and the oxidizing stream 128 can be adjusted by a system operator to achieve the desired concentrations of coal and oxygen to react in the gasifier 110.

In the example illustrated the input stream 126 and the oxidizing stream 128 are shown as two separate streams that are independently fed into the gasifier 110. However, it is understood that the feed location and mixing of the input and oxidizing streams 126, 128 may be adjusted to suit the requirements of the specific gasifier used in the coal gasification system 100. For example, the input and oxidizing streams may be pre-mixed prior to entering the gasifier or they may be mixed at the point of combustion within a burner in the gasifier.

The gases leaving the gasifier 110, and any flyash entrained therein, form an exhaust stream 130, which 130 may include syngas, flyash, unreacted oxygen, conveying fluid and any other desired product or by-product exiting the gasifier 110 in gaseous form. The exhaust stream 130 is then routed through a number of other system components (described in detail below) which may vary the properties or composition of the exhaust stream 130. In the coal gasification system 100, the exhaust stream 130 passes through the filter 114, heat exchanger 116 and injection cooler 118 before arriving at the compressor 120, where the exhaust stream 130 is compressed and sent downstream for further processing. Other examples of a coal gasification system may not include the heat exchanger 116.

In some examples of a coal gasification system 100, a water stream is also introduced into the gasifier 110. The water introduced may be in liquid or gaseous form and may be fed into the gasifier 110 as a separate incoming stream, or as a component of the input or oxidizing streams 126, 128. Introducing additional water into the gasifier 110 may moderate the reaction temperature and may provide an additional source of hydrogen and oxygen molecules to the reaction. However, adding a separate water stream into the gasifier 110 also increases the total volume (and mass) of the exhaust stream 130 that flows downstream from the gasifier 110 during operation. Increasing the total volume of the exhaust stream 130 may require an increase in the energy required to compress the exhaust stream 130 when it reaches the compressor 120.

In other examples of the coal gasification system 100, the gasifier 110 is configured to operate without the use or introduction of a separate water stream. Such a gasifier 110 is described as water-free, or being free from added water, as water (in its solid, liquid, vapour or gaseous form) is not intentionally introduced into the process. However, even in the absence of a water stream, the gasifier 110 will receive some water as there is moisture contained in the pulverized coal that is fed into the gasifier 110. While the pulverized coal is commonly dried before being fed into the gasifier 110 the coal may still contain 0.1 to 10 percent water (mass) after being dried. In this description, the term “water-free” or “free from added water” means a gasifier 110 that is operated without intentionally introducing water or steam into the reaction in addition to the moisture contained in the pulverized coal.

In some examples, using a given flow rate of the input and oxidizing streams 126, 128, operating the coal gasification system 100 as a water-free system may reduce the total volume of the exhaust stream 130 that enters the compressor 120 which may allow the compressor size and operating power requirements to be reduced. In other examples, for a given compressor size/configuration and exhaust stream 130 flow rate, the input and oxidizing stream 126, 128 flow rates may be increased when water stream is removed.

In some examples of the coal gasification system 100 the walls of the gasifier 110 are cooled using known cooling methods, such as providing a circulated cooling water stream 132 that absorbs heat from the gasifier 110 to produce a superheated steam stream 134. The superheated steam stream 134 may be used for any suitable purpose, including driving machinery or providing heat. Like the interaction between the input and oxidizing streams 126, 128, the specific cooling requirements of the gasifier 110 may depend on the specific gasifier used.

After leaving the gasifier 110, the exhaust stream 130 flows into the filter 114. The cooling of the gasifier 110 described above also cools the exhaust stream 130 exiting the gasifier 110 to a temperature between 100 degrees and 400 degrees Celsius. In some examples the exhaust stream 130 is cooled to approximately 200 degrees Celsius prior to entering the filter 114.

The filter 114 separates the flyash, and other solid matter, from the exhaust stream 130. In the example shown, the filter 114 is any suitable mechanical filter such as bag filter made of fabric (also referred to as a bag house or bag house filter), a cyclone separator or a combination of a cyclone separator positioned upstream of a fabric bag filter. In a cyclone separator the exhaust stream 130 is rotated about a central axis causing the entrained flyash to become separated from the exhaust stream 130 by centrifugal force. The flyash is removed from the filter 114 and the clean exhaust stream 130 continues downstream. In a bag filter, the flyash is separated from the exhaust stream 130 by passing the exhaust stream 130 through a fabric mesh or net having openings that are smaller than most flyash particles to block the passage of flyash particles while allowing the exhaust gases to pass. The opening size, total area of the bag and the material and mechanical properties of the mesh (e.g. strength, melting point, corrosion resistance) may be based on the composition of the exhaust stream 130 and the operating pressure of the system.

A combination filter/separator passes the exhaust stream 130 through both a cyclone separator and a fabric bag filter. Flyash separated by the filter 114 is cleaned from (or cleared out of) the filter 114, particularly bag filters, using a stream of cleaning gas that is intermittently pulsed through the filter bag. The pulse of cleaning gas agitates the filter bag and dislodges flyash particles trapped therein. Filter cleaning gas is introduced by cleaning gas stream 136 and flyash is carried away from the filter, entrained in filter cleaning gas, via filter waste stream 138. The filter cleaning gas can be any suitable gas, including nitrogen, carbon dioxide, carbon monoxide or syngas (possibly recirculated from the exhaust stream 130 downstream of the filter).

Optionally, the filter 114 may be gas-tight or sealed so that flyash and exhaust gases from the exhaust stream 130 do not leak from the exhaust stream 130 into the surrounding environment or atmosphere. The filter 114 may be sealed using any suitable sealing apparatus, including gaskets, o-rings, interference fits and welded connections. The particular sealing apparatus used may depend on the properties of the exhaust stream 130 (i.e. corrosiveness, etc.) and the operating pressure of the exhaust stream 130. For example, the seals on the filter 114 may be selected to withstand the corrosive nature of the exhaust stream 130 and an operating pressure of 0.7 to 2 atmospheres.

Optionally, as indicated by the use of dotted lines, some or all of the filter waste stream 138 can be recaptured as a flyash recovery stream (also referred to as the recovered flyash stream) 140, formed from flyash entrained in the filter cleaning gas. The flyash recovery stream 140 can then be fed back into the coal supply 112 (as shown) or directly combined with the input stream 126 downstream of the coal supply 112 to be fed into the gasifier 110. The flyash separated from the exhaust stream 130 may still contain useable amounts of carbon and may be re-burned in the gasifier 110 along with fresh coal supplied by the input stream 126. This process is also referred to as flyash re-circulation or flyash recycling. In coal gasification systems 100 that include a flyash recycling process the filter 114 is a dry filter that can separate flyash from the exhaust stream 130 in a state that is suitable for re-combustion.

In other examples of coal gasification systems 100 that do not include flyash recycling, the flyash may not need to be kept in a re-combustible state and the filter 114 may be any known filter type, including water scrubbers and water quenchers, wet electrofilters, candle filters with candles of either ceramic material or porous stainless steel.

In the example of the coal gasification system 100 illustrated, the heat exchanger 116 is connected intermediate the filter 114 and the injection cooler 118. When positioned downstream of the filter 114, the heat exchanger 116 is exposed to the post-filter exhaust stream 130 which contains less flyash than the exhaust stream 130 exiting the gasifier 110. The lower flyash concentration may reduce heat exchanger 116 clogging and fouling and may improve heat exchanger 116 performance. Positioning the heat exchanger 116 upstream of the injection cooler 118 exposes the heat exchanger 116 to a higher temperature exhaust stream 130 (approximately 200 degrees Celsius) than the being positioned downstream of the injection cooler 118 where the exhaust stream 130 temperature may be approximately 30-60 degrees Celsius. In other examples, the heat exchanger 116 may be located upstream from the filter 114 or downstream of the injection cooler 118, or the coal gasification system may not include a heat exchanger 116.

In addition to fouling caused by flyash, and any other exhaust stream 130 contaminants, the heat exchanger 116 is also exposed to corrosive chemicals contained in the exhaust stream 130, including hydrochloric acid vapours. The heat exchanger 116 lifespan may be extended by selecting a heat exchanger constructed from corrosion-resistant materials and by controlling the heat transfer process (for example to avoid the dew point of the hydrochloric acid vapours).

The heat exchanger 116 receives the filtered exhaust stream 130 that, as described above, is approximately 200 degrees Celsius. The heat exchanger 116 may be any type of non-mixing heat exchanger known in the art including, for example, tube and shell, plate and frame, and plate fin heat exchangers. The exhaust stream 130 can serve as the hot stream in the heat exchanger 116 and is used to heat a coal dryer stream 142. Optionally, the heat exchanger 116 may be configured to heat one or more additional process streams 142, for example a steam stream or a boiler water pre-heat stream.

The coal dryer stream 142 is a gaseous stream that is supplied to a coal dryer 144 for drying the pulverized coal prior to introducing the coal into the gasifier 110. The coal dryer 144 and other aspects of an example of the coal supply 112 are explained in further detail below. The coal dryer stream could be nitrogen from the air separation unit or carbon dioxide from a downstream process.

In examples of the coal gasification system 100 that include the heat exchanger 116, the temperature of the exhaust stream 130 is reduced after it has been passed through the heat exchanger 116. This lower temperature exhaust stream 130 then enters the injection cooler 118 in which the temperature of the exhaust stream 130 is further decreased. The injection cooler 118 described in this description is a water quench cooler (also referred to as a quencher) supplied by a quencher water supply 166. In other examples of the coal gasification system 100, any suitable cooler/heat exchanger could be used in place of the quencher-type injection cooler 118.

Within the injection cooler 118, the incoming water supply 166 mixes with the exhaust stream 130 thereby cooling the exhaust stream 130 and contaminating the quenching water with residual flyash and other chemicals from the exhaust stream 130. The contaminated, and warmed, waste water is drawn from the quencher as a quencher waste water stream 168 to undergo additional processing and treatment. At the outlet of the injection cooler 118, the temperature of the exhaust stream 130 is reduced to a temperature that is safe and suitable for entering the compressor 120 and being subjected to further downstream processing. In some examples, the temperature of the exhaust stream 130 as it exits the injection cooler 118 can be 30-60 deg C., and in some examples is 55 deg C.

An exhaust stream 130 that is passed through the heat exchanger 116 before reaching the injection cooler 118 is referred to as a pre-cooled exhaust stream 130. When a pre-cooled exhaust stream 130 reaches the injection cooler 118 it does not require as much cooling as a comparable exhaust stream that has not been passed through the heat exchanger 116. Accordingly, the cooling load placed on the injection cooler 118 is smaller when using a pre-cooled exhaust stream 130, which may allow the quencher to operate using a smaller quencher water supply 166 which may result in a reduction in the amount of contaminated waste water exiting the quencher via stream 168. Optionally, a portion of the quencher waste water 168 can be diverted as a quencher water recirculation stream 170 which can be combined with the incoming quencher water supply 166 to be passed through the injection cooler 118 for a second, and possibly subsequent pass. Use of the quencher water recirculation stream 170 (also referred to as a quencher recycling stream, or an injection cooler recycling or recirculation stream) may further reduce the volume of contaminated water that is discharged as quencher waste water 168.

After being cooled to the desired processing temperature (or compressor temperature), the exhaust stream 130 enters the compressor 120 to be compressed and sent downstream for further processing. The compressor 120 may be any suitable compressor, including a single or multi-stage radial compressor, a single or multi-stage axial compressor, a multi-stage axial-radial centrifugal compressor, a blower or a screw compressor. The specific operating parameters of the compressor 120, for example the flow rate and the downstream pressure, may depend on the specific composition of the exhaust stream 130, the desired downstream pressure, and other system characteristics selected or determined by a system operator. Any excess moisture, water or other liquids that condense in the compressor 120 are removed as a compressor drain stream 172.

Referring now to FIG. 2, an example of a coal supply 112 is illustrated. As described above, the coal dryer stream 142 passing through the heat exchanger 116 is fed into an inlet of the coal dryer 144. The coal dryer 144 may be any known coal dryer, and, in some examples, the coal dryer can be integral with the pulverizer. The coal drying gas forming the coal dryer stream 142 may be any suitable gas including, for example, nitrogen, air, CARBON DIOXIDE and any combination thereof, and may be supplied from an air separator (not shown) or any other suitable supply. When in use, coal is introduced into the coal dryer 144 via a raw coal stream 146. Within the coal dryer 144 the raw coal stream 146 is mixed with the warmed coal dryer stream 142 and moisture contained in the raw coal is transferred from the coal into the coal drying gas and carried away from the coal dryer 144 by the coal dryer exhaust stream 148. The amount of moisture contained in the raw coal stream 146 and the corresponding amount of moisture that is carried away in the coal dryer exhaust stream 148 depends on the characteristics of the coal provided.

Once dried to a pre-determined dryness level, the coal exits the coal dryer 144 as a dried coal stream 150 that is fed into a coal storage apparatus, for example a coal silo 152 where it is accumulated and stored prior to being fed into the gasifier 110. Optionally, the flyash recovery stream 140 is also fed into the coal silo 152 and mixed with the dried coal. This mixed fuel stream 154 (which may include only coal in systems that do not have flyash recycling) is then passed through any suitable process control hardware, for example a control valve 156 and flow meter 158 for controlling and monitoring the fuel flow rate respectively. The flow meter 158 may be a mass flow meter or a solids flow meter.

After passing through the process control hardware, the mixed fuel stream 154 enters a dense phase conveying device 160 where it is mixed and entrained with the conveying gas stream 162 to form the input stream 126 that is supplied to the gasifier 110.

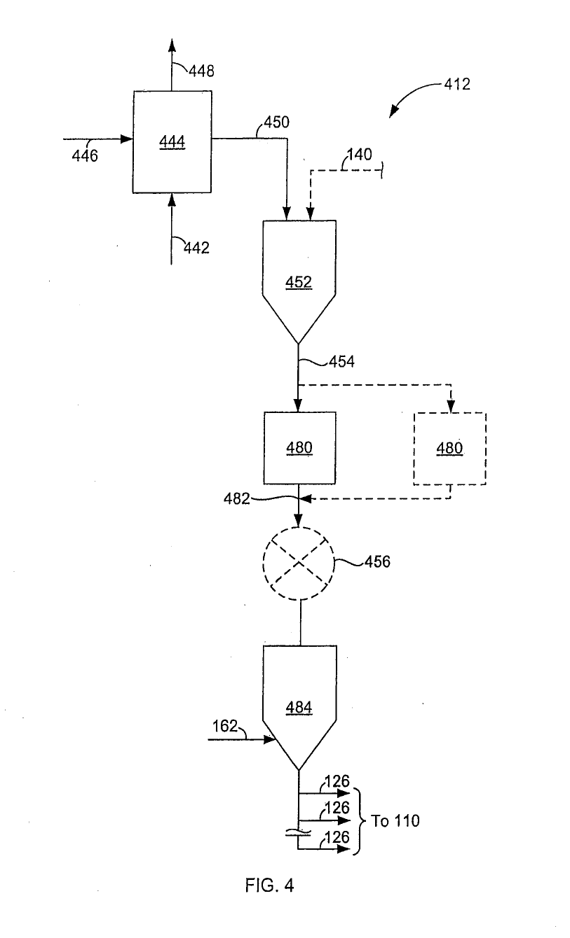

Referring to FIG. 4, another example of a fuel supply system for supplying fuel to a gasifier. The fuel supply system can be configured to provide any suitable fuel to the gasifier, including pulverized coal, a mixture of pulverized coal and recycled flyash and any other suitable fuel material. One example of a fuel supply system is a pulverized coal supply system 412 for use with the coal gasification system 100 is illustrated. The coal supply 412 has similarities to the coal supply 112 illustrated in FIG. 2, and like features are identified by like reference characters, incremented by 300.

One example of the coal supply system 412 includes a coal dryer 444 that has a coal inlet that is configured to receive raw coal, for example pulverized coal, from a raw coal stream 446. The coal dryer 444 also includes a drying fluid inlet for receiving the coal dryer stream 442 and a drying fluid outlet connected to the coal dryer exhaust stream 448. As described in detail above, the coal dryer stream 442 can be heated by passing it through a heat exchanger, for example heat exchanger 116 (FIG. 1), that is disposed downstream from the gasifier, for example gasifier 110).

Like coal dryer 144, when in use the coal dryer 444 receives raw coal and exposes the raw coal to the coal drying fluid, for example pre-heated nitrogen gas, from coal dryer stream 142, which can allow moisture from the raw coal to be transferred to the coal drying fluid and be removed from the coal dryer 444 via the coal dryer exhaust stream 148.

Having been dried to a pre-determined dryness, the coal is removed from the coal dryer 444 via a coal outlet and is conveyed to a coal storage apparatus via a dried coal stream 450. The coal storage apparatus can be any suitable vessel or container that can hold the dried coal received from the coal dryer 444. Using a coal storage apparatus can allow coal to be supplied downstream of the coal storage apparatus at a generally constant rate even if dried coal is received from the coal dryer 444 in batches, or at a different flow rate than is desired downstream from the coal storage apparatus.

In the present example, the coal storage apparatus is a feed hopper 452. The feed hopper 452 can be a single vessel, or multiple vessels/containers communicably connected to enable the transfer of coal therebetween. The feed hopper 452 receives the dried coal stream 450 from the coal dryer 444 and optionally (as indicated by the use of dashed lines) can be configured to receive coal and/or flyash from the flyash recovery stream 140 described above.

Once received in the feed hopper 452 the coal, and/or a mixture of coal and recycled flyash, can be drawn from the feed hopper 452, through a feed hopper outlet, as a fuel stream 454. In some examples, the coal dryer 444 and the feed hopper 452 can be maintained at a first pressure that is below the expected operating pressure of the gasifier 110, for example at approximately atmospheric pressure. In such examples, the pressure of the fuel stream 454 drawn from the feed hopper 452 must be raised to substantially the same operating pressure as the gasifier 110 before the fuel stream 454 reaches the gasifier 110 or other system component operated at a positive pressure, such as, for example, a distribution vessel 484, which, in some examples, operates at a pressure of approximately 0.25-3 bar.

To convey the coal and/or flyash in the relatively low pressure fuel stream 454 to the relatively high pressure distribution vessel 484, the coal supply system 412 includes a mechanical conveyance apparatus that is configured to move a selected solid material (e.g. coal and/or a mixture of coal and flyash) from a first or low pressure region to a second or high pressure region. In some examples, the pressure in the second or high pressure regions may be between 0.1 and 5.0 and optionally between 0.25 and 3.0 atmospheres greater than the first pressure.

One example of a mechanical conveyance apparatus is an intermediate vessel, for example a lock hopper, that is configured to function like an airlock connected between the low pressure and high pressure regions of the system. Such a lock hopper operates in a batch operation in which a low pressure inlet on the lock hopper (for example a valve) is opened to allow solid material (i.e. coal and/or flyash) to flow into the lock hopper. The low pressure inlet can then be closed, optionally the pressure in the lock hopper can be increased to a desired, higher pressure, and then a high pressure outlet (for example a valve) can be opened allowing the solid material in the lock hopper to move into the high pressure portion of the system, for example the distribution vessel 484.

In some instances, the inlet and outlet valves on the lock hoppers are subjected to high stresses and can fail, become fouled and/or become otherwise inoperable which can result in a shutdown of the coal supply system. The batch operation process of lock hoppers (and other similar vessels) can also lead to pressure and/or loading fluctuations in the distribution vessel 484 each time the lock hopper opens and dumps its load of coal and/or flyash into the distribution vessel 484. Such pressure and/or loading fluctuations in the distribution vessel 484 can produce fluctuations in the flow rate of the coal exiting the distribution vessel 484 (and feeding the burners of the gasifier 110), which may be undesirable in some instances, for example when a user wishes to maintain a constant ratio of coal to oxygen in the gasifier 110.

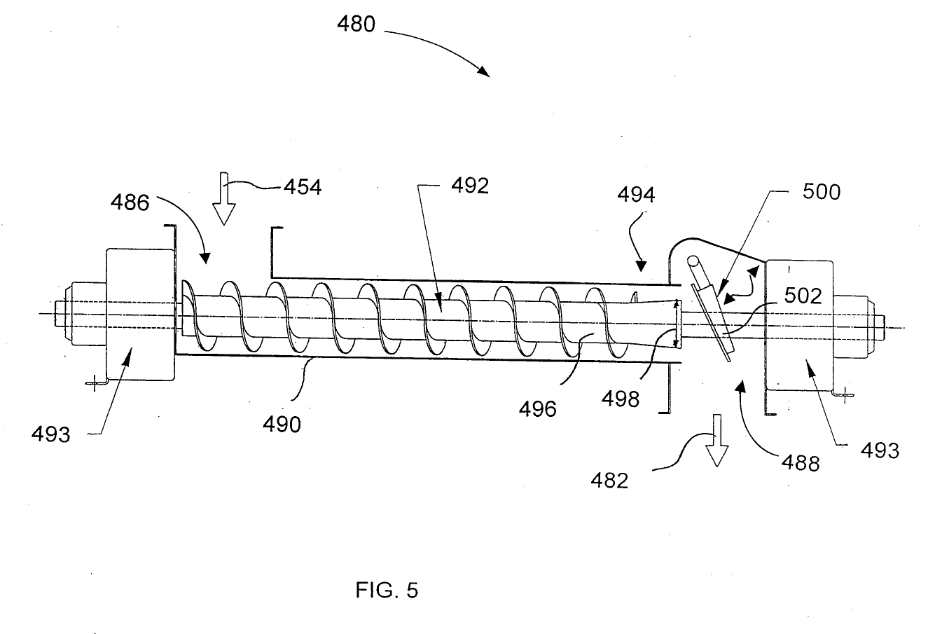

Referring to FIGS. 4 and 5, another example of a mechanical conveyance apparatus is a solid material pumping apparatus or material feeder, herein referred to as a dust pump 480. The mechanical conveyance apparatus can be operably connected to any suitable power supply, for example a motor, that can supply operating power to the mechanical conveyance device.

In some examples the dust pump 480 can be configured to operate as a continuous process apparatus (as opposed to a batch process apparatus) that is operable to convey solid material (coal and/or flyash) from the feed hopper 452 to the distribution vessel 484 (or other component) at a substantially constant flow rate. Optionally, the dust pump 480 can be operable at multiple operating speeds, each operating speed providing a different, but substantially constant, flow rate. The dust pump 480 may be selected from any suitable solid material pumping apparatuses, such as the X-Pump™ brand of material feeders manufactured by Claudius Peters Technologies.

In the example illustrated in FIGS. 4 and 5, the coal supply system 412 comprises a dust pump 480 connected between the feed hopper 452 and the distribution vessel 484. The dust pump 480 has a low pressure inlet 486 for receiving the fuel stream 454 and a high pressure outlet 488 connected to a high pressure fuel stream 482. Optionally (as indicated by the use of dashed lines), the coal supply system 412 can include two or more dust pumps 480 connected in parallel so that a first dust pump 480 can be in use while a second dust pump 480 is offline, for example being serviced or replaced. Such a redundant configuration may increase up-time of the coal supply system 412.

Referring to FIG. 5, a cross sectional view of a portion of an example of a dust pump 480 is illustrated. The dust pump 480 is not a pneumatic conveying device, instead it is a mechanical auger-type pump that receives the pulverized coal and/or flyash from the fuel stream 454 via the low pressure inlet 486 and compresses the particles toward the end of the dust pump housing 490 using an auger screw 492 rotatably supported on a pair of spaced apart bearing assemblies 493 and received in the housing. The dust pump 480 can include a compression portion 494 in which the housing 490 and the central portion of the auger screw 492 cooperate to compress the coal and/or flyash into a solid (or at least substantially gas-impermeable) plug toward the high pressure outlet 488 of the dust pump 480. In the illustrated example the coal and/or flyash is compressed between the housing 490 and a downstream portion of the central shaft 496 of the auger screw 492 that has a larger diameter 498 than the upstream portion of the central shaft 496. Increasing the diameter 498 of the central shaft 496 reduces the size of the annular gap created between the central shaft 496 and the housing 490. Pulverized coal that is urged into the smaller annular gap by the rotation of the auger screw 492 is compressed to form a solid plug-like member that it is generally gas impermeable. The shape of the central shaft 496 can be selected to provide the desired amount of compression for a given feedstock.

The compressed coal plug effectively acts as a sealing member or pressure barrier that seals the high pressure outlet 488 of the dust pump 480 and prevents back-flow of gas and other material from the relatively high pressure area in the distribution vessel 484 into the relative low pressure areas upstream from the dust pump 480, for example the feed hopper 452. In some examples, the plug of compressed coal and/or flyash can be the only sealing member used to prevent back-flow of material through the dust pump 480.

As the auger screw 492 rotates, the plug can be advanced through the narrowed annular gap and toward the high pressure outlet 488 until it reaches an opening in the housing 490. When the plug reaches the opening in the housing, the plug is no longer supported and/or retained by the housing 490 of the pump 480 and the plug can then crumble to provide a granular mixture of coal and/or flyash for the high pressure fuel stream 482.

Optionally, in some examples the sealing member of the mechanical conveyance apparatus 480 can also include a back-flow inhibiting apparatus, including, for example a check-valve or non-return valve 500, that can inhibit the back-flow of material through the mechanical conveyance apparatus (i.e. a flow of material toward the coal storage apparatus).

In the illustrated example, the non-return valve 500 includes a sealing flapper 502 that is pivotally connected adjacent the downstream end of the dust pump 480. When coal material is be ejected from the housing 490, the flapper 502 is pivoted to its open position as illustrated in FIG. 5. When coal material is not being ejected from the housing, the flapper 502 pivots to a closed position in which the flapper 502 covers the downstream end of the housing 490 and provides a generally gas impermeable seal.

In the illustrated example, the dust pump 480 is connected to the distribution vessel 484 such that the high pressure fuel stream 482 can enter the distribution vessel without the use of a conveying fluid. For example, the outlet of the dust pump 480 can be connected to an upper portion of the distribution vessel 484 (i.e. toward to top of the vessel) such that coal and/or flyash exiting the dust pump 480 falls into the distribution vessel 484 due to gravity forces. In such examples the dust pumps 480 can be directly connected to the distribution vessel 484, and/or can be connected using any suitable conduit or pipe. In other examples, the high pressure fuel stream 482 may be conveyed to the distribution vessel 484 using any other suitable means, including, for example, a conveying fluid, an additional auger screw or a conveyor belt.

Operating a dust pump 480, or other suitable coal conveyance apparatus, in a generally continuous manner as described above provides a generally continuous coal flow/feed rate from low pressure vessels (for example the feed hopper 452) to high pressure vessels (for example the distribution vessel 484) without the need for lock hoppers or conveying fluids. In other examples, a conveying fluid can be used to convey the high pressure fuel stream 482 from the outlet of the dust pump 480 to the inlet of the distribution vessel 484.

The coal supply system 412 can optionally include any combination of process control hardware, including a flow control valve 456, a flow meter, pressure regulators and a variety of fluid and solid conduits. While illustrated as being disposed downstream of the dust pump 480, it is understood that the flow control valve 456, and any other process control hardware, can be installed in a variety of user-selected locations throughout the coal supply system 412.

The coal supply system 412 can include a fuel distribution apparatus for receiving the coal and/or flyash from the high pressure fuel stream 482 and feeding the coal and/or flyash into the gasifier 110 in a desired manner. The fuel distribution apparatus can optionally be configured to moderate the rate at which fuel is fed into the gasifier 110, distribute the fuel supply amongst the burners of the gasifier 110 in a desired manner and/or otherwise process the fuel as desired. One example of a fuel distribution apparatus is the distribution vessel 484.

In some examples, the distribution vessel 484 can be configured to receive the coal and/or flyash, the fuel, from the high pressure fuel stream 482 and distribute the fuel to the burners of the gasifier 110. In the example illustrated the distribution vessel 484 includes a plurality of gasifier input streams 126, extending from a plurality of outlets in the distribution vessel 484, each of which can be connected to a respective burner on the gasifier 110. The number of gasifier input streams 126 extending from the distribution vessel 484 can be selected based on the configuration of the particular gasifier 110 used in a given installation, system production or flowrate factors and/or any other suitable criteria. In other examples, the distribution vessel 484 may provide a number of outlets, for example gasifier input streams 126, that is different than the number of burners on the particular gasifier 110. In such instances, the gasifier input streams 126 may be further separated and/or combined downstream from the distribution vessel 484.

In some examples, one or more conveying gas streams 162 can be connected to the distribution vessel 484 for pneumatically conveying the coal and/or flyash along each gasifier input stream 126, as described above. Optionally, a single conveying gas stream 162 can be connected to the distribution vessel 484 and the conveying gas can be routed to the respective gasifier input streams 126 within the distribution vessel 484. Alternatively, or in addition, each gasifier input stream 126 may be supplied with conveying gas by a respective conveying gas stream 162.

In some examples, including a distribution vessel 484 in the coal supply system 412 can enable a single dust pump 480 (or multiple dust pumps 480) to be used to supply the coal and/or flyash fuel to a plurality of burners on the gasifier 110. In other examples, the coal supply system 412 may not include a distribution vessel 484 and the coal supply system 412 can include a plurality of dust pumps 480 connected, directly or indirectly, to one or more burners. For example, a coal supply system 412 used to supply coal to a four-burner gasifier 110 may include four dust pumps 480, one directly connected to each burner. Alternatively, such a coal supply system 412 could include two dusts pumps 480, each supplying coal to two burners, or optionally the system could include one, three, or more than four dust pumps 480.

In the examples illustrated, the coal gasification system 100 is an atmospheric pressure coal gasification system that is configured to operate at approximately atmospheric pressure (at an operating pressure between 0.7 and 2.0 atmospheres) as opposed to the high pressure, or pressurized, coal gasification systems known in the art (at operating pressures between 2-4 MPa). For the purpose of this description, the term atmospheric pressure means an absolute operating pressure between 0.7 and 2.0 atmospheres, approximately 70 kPa to 202.6 kPa, or a gauge pressure of between zero and one atmospheres. Under this definition, the term “atmospheric pressure” is not limited to exactly 101.3 kPa. The coal gasification system 100 may also be described as operating at a positive pressure, which means an absolute pressure greater than one atmosphere or a gauge pressure greater than zero. In some examples, the coal gasification system may operate at a gauge system pressure of 2 kPa to 100 kPa

When the coal gasification system 100 operates at a positive pressure any leaks or containment failures in the system result in process products being vented or released from the system 100 into the surrounding environment, as opposed to having air drawn into the system. Having process products escape from the system instead of drawing air into the system may be advantageous as the process products contain flammable and/or reactive chemicals that may combust or explode in the presence of oxygen if air or oxygen is drawn into the system through a leak. Operating a system at a negative pressure (less than atmospheric) may allow air to be drawn into the system through system leaks. However, other examples of the coal gasification system may be configured to operate at negative pressures.

Operating the coal gasification system 100 at atmospheric pressure may reduce the need for specialized, high pressure machinery and may allow a system designer and/or system operators to use existing or “off the shelf” (or only slightly modified) components in the design and construction of the coal gasification system 100. For example, a plurality of atmospheric pressure filters and heat exchangers are known, and the filter and heat exchanger used in the coal gasification may be selected from a variety of suitable, off the shelf options. Off the shelf components may be cheaper than specialized or custom design components which may reduce the overall cost of the atmospheric coal gasification system.

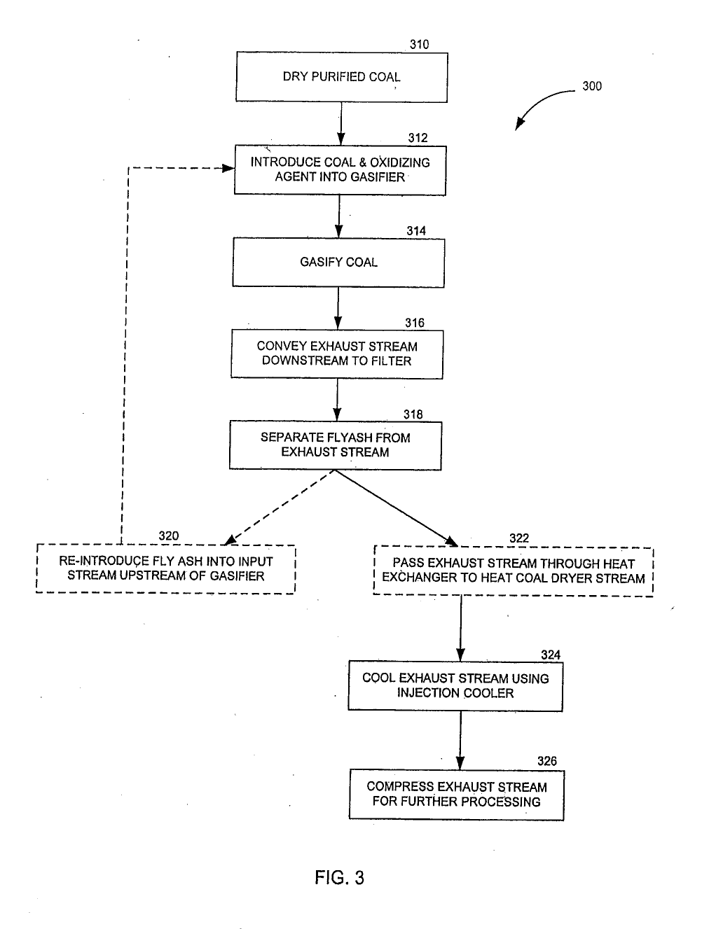

Referring now to FIG. 3, an example of a coal gasification process 300 is illustrated. The process begins at step 310 in which pulverized coal is dried to remove excess moisture. The drying of the pulverized coal may be carried out in a coal dryer using the coal dryer stream described above, or any other suitable apparatus.

After the coal has reached its desired dryness, it is conveyed to the gasifier, at step 312, where it is combined with the appropriate amount of oxygen, for example from the oxidation stream. At step 314 the coal is gasified, in the presence of the oxygen, to produce syngas, flyash and a plurality of additional process by-products that exit the gasifier as an exhaust stream.

At step 316, the combustion products from the gasifier that make up the exhaust stream are conveyed downstream, away from the gasifier, to a filter. The filter may be similar to the filter 114 described above, or any other type of suitable filter. As the exhaust stream passes through the filter, at step 318, at least a portion of the flyash is separated out of the exhaust stream.

Optionally, as indicated by the use of dotted lines, the process proceeds to step 320 in which the flyash separated from the exhaust stream by the filter, at step 318, is re-introduced into the gasifier along with the coal and oxygen at step 312. Step 320 may be performed when the coal gasification system uses a bag filter or cyclone/bag filter as described above, and may be skipped if the filter used leaves the extracted flyash in a non-combustion-ready condition.

Also optionally, and independent of whether step 320 is included, the process may proceed to step 322 in which the exhaust stream is passed through a heat exchanger to warm the coal dryer stream. Whether the process involves step 320 may depend on whether a suitable heat exchanger is included in the system.

At step 324 the exhaust stream is cooled, or further cooled if the process included step 322, by passing the exhaust stream through an injection cooler or quencher (or other suitable heat exchanger). Once cooled to the desired process temperature, the process proceeds to step 326 in which the exhaust stream is compressed and sent downstream for further processing.

What has been described above has been intended to be illustrative of the invention and non-limiting and it will be understood by persons skilled in the art that other variants and modifications may be made without departing from the scope of the invention as defined in the claims appended hereto.

1. A fuel supply system for supplying pulverized feedstock to a gasifier, the fuel supply system comprising:
(a) a feedstock storage apparatus for storing at least pulverized feedstock, the feedstock storage apparatus operating at a first pressure;
(b) a mechanical conveyance apparatus communicably linking the feedstock storage apparatus to a fuel distribution apparatus, the mechanical conveyance apparatus being operable to continuously convey the pulverized feedstock from the feedstock storage apparatus to the fuel distribution apparatus at a first flow rate, the fuel distribution apparatus operating at a second pressure which is greater than the first pressure;
the fuel distribution apparatus comprising at least one outlet communicably connected to at least one burner on the gasifier for transferring pulverized feedstock from the fuel distribution apparatus to the at least one burner.

2. The fuel supply system of claim 1, wherein the mechanical conveyance apparatus is configured to convey at least pulverized feedstock from the feedstock storage apparatus to the fuel distribution apparatus in the absence of a pneumatic conveying fluid.

3. The fuel supply system of claim 1, wherein the second pressure is between 0.25 and 3.0 atmospheres greater than the first pressure.

4. The fuel supply system of claim 1, wherein the mechanical conveyance apparatus is configured to provide a sealing member for maintaining the second pressure in the fuel distribution apparatus and inhibiting a back flow of pulverized feedstock from the fuel distribution apparatus to the feed hopper.

5. The fuel supply system of claim 4, wherein the mechanical conveyance apparatus is a dust pump, the dust pump comprising:
(a) a housing having an inlet connected to the feedstock storage apparatus, an outlet connected to the fuel distribution apparatus, and a housing extending therebetween;
(b) an auger rotatably received within the housing for conveying at least pulverized feedstock from the inlet to the outlet; and
(c) a motor drivingly connected to the auger for selectably rotating the auger.

6. The fuel supply system of claim 5, wherein the auger comprises a central shaft, and the central shaft and the housing cooperate to define a compression portion that is operable to compress the pulverized feedstock into a plug which forms the sealing member.

7. A method of supplying fuel to a gasifier having a plurality of burners, the process comprising the steps of:
(a) providing a supply of fuel contained in a feedstock storage apparatus, the feedstock storage apparatus operating at a first pressure;
(b) providing a mechanical conveyance apparatus that communicably links the feedstock storage apparatus to a fuel distribution apparatus, the fuel distribution apparatus operating at a second pressure that is higher than the first pressure;
(c) operating the mechanical conveyance apparatus to continuously convey at least a portion of the fuel from the feedstock storage apparatus to the fuel distribution apparatus at a first flow rate; and
(d) continuously supplying the fuel at a second flow rate from the fuel distribution apparatus to the plurality of burners.

8. The method of claim 7, wherein step (c) comprises conveying the feedstock from the feedstock storage apparatus to the fuel distribution apparatus in the absence of a conveying fluid.

9. The method of claim 7, wherein the first flow rate is a constant flow rate.

10. The method of claim 7, wherein step (c) comprises selecting the first constant flow rate from a plurality of predetermined flow rates.

11. The method of claim 7, further comprising the step of adjusting the first flow rate based on an operating condition of the gasifier.

12. The method of claim 7, wherein the mechanical conveyance apparatus comprises an inlet in communication with the feedstock storage apparatus and an outlet in communication with the fuel distribution apparatus and a housing extending therebetween, and step (c) comprises conveying the fuel within the housing from the inlet to the outlet.

13. The method of claim 7, wherein the mechanical conveyer comprises a compression portion, and step (c) further comprises compressing the fuel in the compression section to create a plug that forms a sealing member between the feedstock storage apparatus and the fuel distribution apparatus.

14. A system for use in a feedstock gasification plant, the system comprising:
(a) a gasifier for receiving an input stream and an oxidizing stream and for expelling an exhaust stream;
(b) the input stream comprising pulverized feedstock within a conveying fluid, and the exhaust stream comprising flyash entrained within syngas; and
(c) the input and oxidizing streams being free from added water so that any water received in the gasifier is substantially limited to moisture contained in the pulverized feedstock.

15. A system for use in a feedstock gasification plant, comprising:
(a) a gasifier receiving an input stream and an oxidizing stream and expelling an exhaust stream and a slag stream;
(b) the input stream comprising pulverized feedstock entrained within a conveying fluid, and the exhaust stream comprising flyash entrained within syngas; and
(c) a filter downstream of the gasifier for receiving the exhaust stream and removing at least a portion of the flyash from the exhaust stream, the filter being selected from the group consisting of a bag filter, a cyclone filter and a combination cyclone and bag filter, and being operable at a pressure that is higher than atmospheric pressure.

16. A system for use in a feedstock gasification plant, comprising:
(a) a dryer for drying pulverized feedstock prior to gasification using a dryer stream,
(b) a gasifier downstream of the dryer, the gasifier being configured to receive an input stream and an oxidizing stream and to expel at least an exhaust stream;
(c) the input stream comprising pulverized feedstock from the dryer entrained within a conveying fluid, and the exhaust stream comprising flyash entrained within syngas; and
(d) a heat exchanger in communication with the exhaust stream downstream of the gasifier and with the dryer stream upstream of the dryer, the heat exchanger being operable to transfer heat from the exhaust stream to the dryer stream when in use.
